(19) United States
(12) Patent Application Publication
(10) Pub. No.: US 2009/0112995 A1
(43) Pub. Date: Apr. 30, 2009

(54) E-MAIL AND FILE TRACKER

(76) Inventors: Martinez Vencia Addae, Austin, TX (US); Fang Lu, Billerica, MA (US); Vandana Mallempati, Austin, TX (US); Jehan S. Moghazy, Arlington, VA (US)

Correspondence Address: IBM CORP (YA);C/O YEE & ASSOCIATES PC, P.O. BOX 802333, DALLAS, TX, 75380, US

(21) Appl. No.: 11/877,764

(22) Filed: Oct. 24, 2007

(51) Int. Cl. G06F 15/16

(52) U.S. Cl. 709/206; 709/220; 709/238

(57) ABSTRACT

A method, system, and computer program product for tracking e-mail and e-mail attachment usage information is provided. A request to track an e-mail is received. The recipients of the e-mail are determined. E-mail usage information for the e-mail is determined for each recipient. A determination is made as to whether the e-mail comprises at least one attachment. Responsive to a determination that the e-mail comprises at least one attachment, attachment usage information for the at least one attachment is determined for each recipient. Recipients are grouped based on a location of each recipient. Path information for the e-mail is generated. Data, comprising the e-mail usage information, the attachment usage information, the path information, and grouping information, is sent to a remote data processing system. A visual representation of the data is displayed at the remote data processing system.

### BACKGROUND OF THE INVENTION

1. Field of the Invention

The present invention relates generally to data processing systems. More particularly, the present invention is directed to a computer implemented method, apparatus, and computer-usable program code for tracking e-mail and e-mail attachments.

2. Description of the Related Art

The Internet is a global network of computers and networks joined together by gateways that handle data transfer and the conversion of messages from a protocol of a sending network to a protocol used by a receiving network. On the Internet, any computer may communicate with any other computer. Information between computers travels over the Internet through a variety of languages, also referred to as protocols. The set of protocols used on the Internet is called the Transmission Control Protocol/Internet Protocol (TCP/IP).

The Internet has revolutionized communications and commerce, as well as being a source of information and entertainment. For many users, e-mail is a widely used format to communicate over the Internet. It is commonplace for users to send e-mail messages to others users through the Internet.

The use of e-mail messages is commonplace for personal and business use. E-mail messages are used by individuals to keep in touch with and communicate with other users. Additionally, e-mail messages provide a medium to collaborate and exchange documents.

Currently, there is no way for a user to individually track the path that an e-mail and any attachments to the e-mail took. Also, a user cannot track how many other users the e-mail touched by region, departments, and so forth. As a result, an e-mail user may be unaware that their confidential e-mail eventually reached other external users or that other users have used e-mail attachments and made changes to the attachment, copied some of the content of the attachment, or forwarded the attachment to other individuals.

Thus, while great strides have been made in the area of e-mail, problems still exist.

### SUMMARY OF THE INVENTION

The present invention provides a method, system, and computer program product for tracking e-mail and e-mail attachment usage information. A request to track an e-mail is received. The recipients of the e-mail are determined. E-mail usage information for the e-mail is determined for each recipient. A determination is made as to whether the e-mail comprises at least one attachment. Responsive to a determination that the e-mail comprises at least one attachment, attachment usage information for the at least one attachment is determined for each recipient. Recipients are grouped based on a location of each recipient. Path information for the e-mail is generated. Data, comprising the e-mail usage information, the attachment usage information, the path information, and grouping information, is sent to a remote data processing system. A visual representation of the data is displayed at the remote data processing system.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which illustrative embodiments may be implemented;

FIG. 2 is a block diagram of a data processing system in which illustrative embodiments may be implemented;

FIG. 3 is a block diagram of a system for tracking e-mail and e-mail attachments in accordance with an exemplary embodiment;

FIG. 4 is a block diagram of a graphical user interface for tracking an e-mail and e-mail attachments in accordance with an exemplary embodiment; and

FIG. 5 is flowchart illustrating the operation of tracking an e-mail and e-mail attachments in accordance with a preferred embodiment.

### DETAILED DESCRIPTION OF THE PREFERRED EMBODIMENT

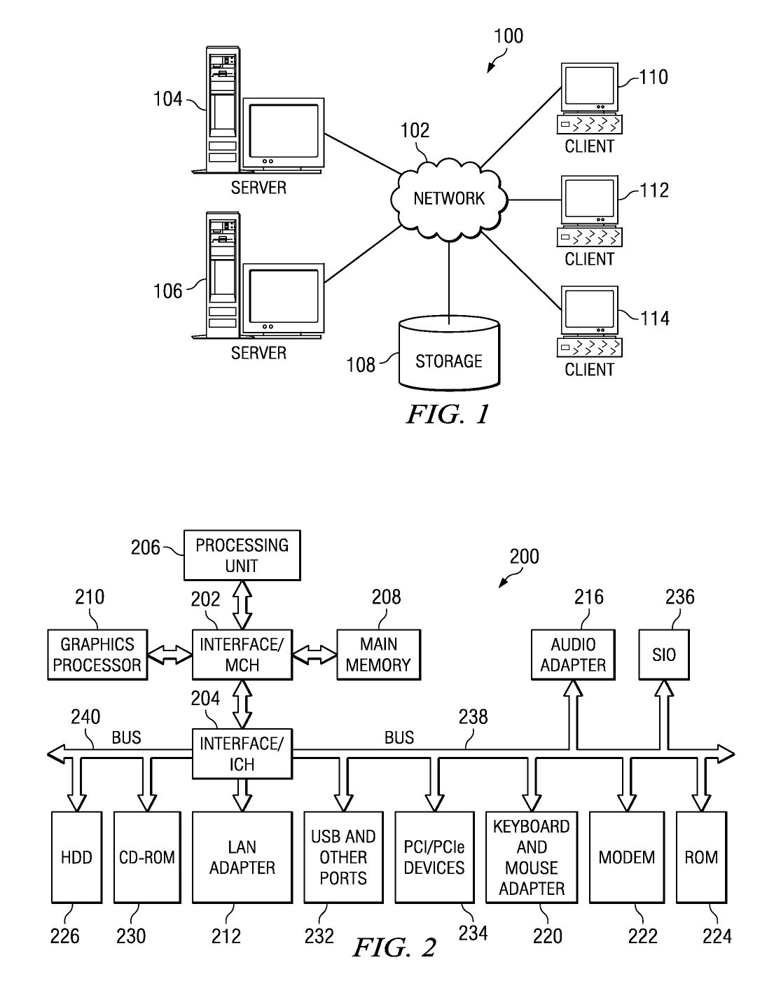

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer-usable program code or instructions implementing the processes may be located for the illustrative embodiments.

In the depicted example, data processing system 200 employs a hub architecture including interface and memory controller hub (interface/MCH) 202 and interface and input/output (I/O) controller hub (interface/ICH) 204. Processing unit 206, main memory 208, and graphics processor 210 are coupled to interface and memory controller hub 202. Processing unit 206 may contain one or more processors and even may be implemented using one or more heterogeneous processor systems. Graphics processor 210 may be coupled to the interface/MCH through an accelerated graphics port (AGP), for example.

In the depicted example, local area network (LAN) adapter 212 is coupled to interface and I/O controller hub 204 and audio adapter 216, keyboard and mouse adapter 220, modem 222, read only memory (ROM) 224, universal serial bus (USB) and other ports 232, and PCI/PCIe devices 234 are coupled to interface and I/O controller hub 204 through bus 238, and hard disk drive (HDD) 226 and CD-ROM 230 are coupled to interface and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to interface and I/O controller hub 204.

An operating system runs on processing unit 206 and coordinates and provides control of various components within data processing system 200 in FIG. 2. The operating system may be a commercially available operating system such as Microsoft® Windows Vista™ (Microsoft and Windows Vista are trademarks of Microsoft Corporation in the United States, other countries, or both). An object oriented programming system, such as the Java™ programming system, may run in conjunction with the operating system and provides calls to the operating system from Java™ programs or applications executing on data processing system 200. Java™ and all Java™-based trademarks are trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course, the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in interface and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

Exemplary embodiments provide for tracking an e-mail and any attachments to the e-mail. Further, exemplary embodiments enable a user to see the path that an email or an attachment took, including the recipient's identity, and to display usage information, such as how many times the e-mail and attachment have been read, copied, forwarded, edited, and so forth.

Exemplary embodiments provide a graphical user interface (GUI) that visually shows the path an e-mail took, including the recipients' identities, usage information, such as how many users the e-mail reached, including how many times the e-mail has been opened, copied, sent, edited, and so forth and where those recipients are located. The location of the recipient can be set to departmental level, a corporate level, a regional level, a geographic level, or any appropriate level for a particular user's implementation.

Exemplary embodiments track attachments to an e-mail by providing an attachment identity tag for every attachment. Attachments are tracked to help the user determine attachment usage information, such as how many times the attachment has been opened, forward, copied, modified, sent, and so forth. The attachment identity tag is monitored, and it allows the owner of the attachment to determine usage information, such as how many times the attachment has been opened, forward, copied, modified, sent, and so forth, after leaving the user. Additionally, the identity of users to whom the attachment has been sent, as well as the identity of users that modified, opened, forwarded, copied, or sent the attachment is also tracked.

Furthermore, exemplary embodiments provide for tracking e-mail usage information. E-mail usage information includes how many times the e-mail itself is opened, copied, sent, forwarded, edited, and so forth, as well as who opened, copied, sent, forwarded, edited, and so forth, and who received the email. Exemplary embodiments use an e-mail identity tag to track usage information of an e-mail.

Tracking e-mails and attachments provide benefits to the corporate, legal, and educational fields. The tracking of e-mails and attachments serves as a document trail for confidential documents, audits, and legal situations. Further, tracking e-mails and attachments will also help detect plagiarism and cheating in educational settings.

Both the e-mail identity tag and the attachment identity tag are generated at the e-mail server and assigned to the e-mail and attachment once the e-mail and attachment is received by the e-mail server. The e-mail identity tag and the attachment identity tags are unique identities assigned to the e-mail and to any attachment to the e-mail. Each separate attachment of an e-mail receives a separate attachment identity tag. For example, an e-mail containing three attachments is assigned a unique e-mail identity tag and each of the three attachments is assigned a separate, unique, attachment identity tag. The e-mail identity tag and attachment identity tags cross-reference each other. The specific convention and method used to generate the e-mail identity tag and the attachment identity tag is irrelevant to the present disclosure, as long the identity tags are unique identity tags.

For example, an e-mail identity tag could be, but is not limited to, a numeric series, an alphabetical series, or an alphanumeric series. The series could be of any length and may be generated in various ways, such as, but not limited to, randomly, or based on the user id, or based on the subject line of the e-mail, or any combination thereof. Similarly, an attachment identity tag may be generated in the same manner as the e-mail identity tag. Further, the attachment identity tag may be based on the name of the specific attachment that the tag is associated with. The attachment identity tag may be based on the e-mail identity tag, such as using the e-mail identity tag as either a prefix or a suffix for the attachment identity tag. Alternatively, the attachment identity tag may be completely different. In either case, in an exemplary embodiment, a database or table is maintained that cross-references an e-mail identity tag for an e-mail with each attachment identity tag associated with the e-mail.

In an exemplary embodiment, displaying the visual representation of the path of the e-mail and/or an attachment, along with associated usage information, may be enabled or disabled at a user's option. Further, in an exemplary embodiment, the e-mail and attachment tracker is an application program interface (API) that works in context with the user's email program and resides on the e-mail server. An API is a set of routines that an application uses to request and carry out services performed by an operating system of a data processing system.

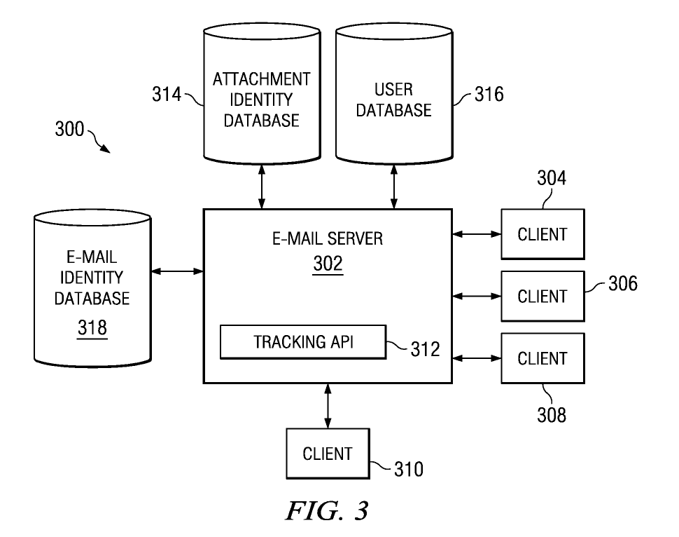

FIG. 3 is a block diagram of a system for tracking an e-mail and e-mail attachments in accordance with an exemplary embodiment. Network 300 is a network capable of transmitting e-mail messages and attachments between client users. Network 300 may be implemented as network data processing system 100 in FIG. 1. Network 300 comprises e-mail server 302 and clients 304, 306, 308, and 310. E-mail server 302 and clients 304, 306, 308, and 310 may be implemented as data processing systems, such as data processing system 200 in FIG. 2. It should be understood that the architecture presented in FIG. 3 is meant solely for the purposes of illustration and in no way limits exemplary embodiments to the architecture depicted. In various alternative exemplary embodiments, network 300 comprises a plurality of e-mail servers and a plurality of clients.

E-mail server 302 comprises tracking API 312, attachment ID db 314, user db 316, and e-mail ID db 318. User db 316 is a database of all the users of e-mail server 302. Each entry for a user in user db 316 has attributes for tracking e-mail and attachment usage information, such as the messages and attachments that the user sends or receives, the particular user that sent the message to the user, and the particular user or users to whom the user sent a message. Each entry for an attachment identity tag in attachment ID db 314 has attributes for tracking attachment usage information, such as how many times the attachment has been opened, forward, copied, modified, sent, and so forth, after leaving the user. Additionally, the identity of users to whom the attachment has been sent, as well as the identity of users that modified, opened, forwarded, copied, or sent the attachment is also tracked. Each entry for an e-mail identity tag in e-mail ID db 318 has attributes for tracking attachment usage information, such as how many times the e-mail itself is opened, copied, sent, forwarded, edited, and so forth, as well as who opened, copied, sent, forwarded, edited, and so forth, the e-mail and who received the email. User db 316, attachment ID db 314, and e-mail ID db 318 reference each other. Tracking API 312 enables the tracking of e-mails and attachments through the use of the user's e-mail program.

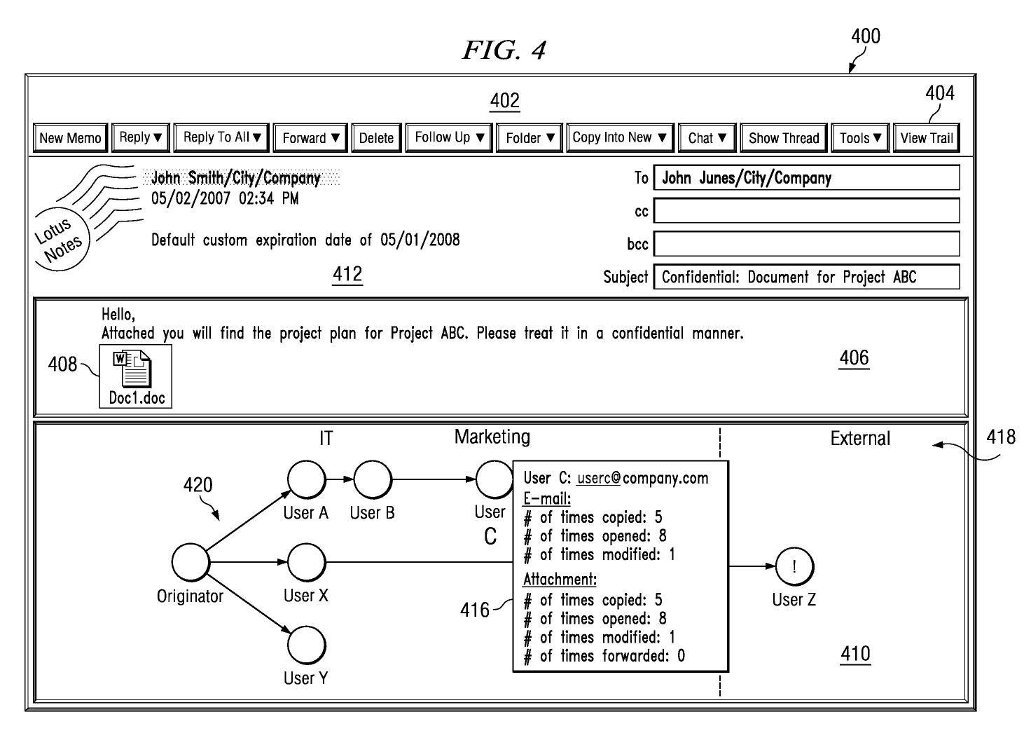

FIG. 4 is a block diagram of a graphical user interface for tracking e-mail and e-mail attachments in accordance with an exemplary embodiment. GUI 400 may be implemented in a data processing system, such as data processing system 200 in FIG. 2. GUI 400 comprises menu bar 402, address area 412, message area 406, and tracking area 410.

Menu bar 402 comprises various commands for generating and sending an e-mail, such as, new memo, reply, reply to all, forward, delete, follow up, folder, copy into new, chat, show thread, tools, and so forth. Menu bar 402 also comprises a command for enabling the tracking of an e-mail and attachments. In FIG. 4, the command to enable or disable tracking is depicted as button 404, called view trail. However, in an alternate embodiment, the enable and disabling of the tracking of an e-mail and attachments is selected via a pull-down or a drop-down menu. Enabling the tracking populates tracking area 410 with the path of the e-mail as well as location information 418.

Message area 406 comprises the e-mail message sent to the recipients and any attachments to the e-mail message. In the present example, the e-mail message in message area 406 states, “Hello. Attached you will find the project plan for Project ABC. Please treat it in a confidential manner.” Attachment 408, entitled Doc1, is also shown in message area 406.

Tracking area 410 comprises path information 420 for the e-mail message in message area 406, as well as location information 418 and usage information 416. Exemplary embodiments allow the location of a recipient of the e-mail message in message area 406 to be tracked at a departmental level, a corporate level, a regional level, a geographic level, or any appropriate level for a particular user's implementation.

In the present example, location tracking for recipients is set to a departmental level. Thus, location information 418 comprises the headings IT (information technology), marketing, and external. All of the recipients are arranged under these headings. The present example comprises the titles of only two (2) departments, IT and marketing, because, in the present example only members of those departments received the e-mail message in message area 406. In other alternate exemplary embodiments, recipients from many other departments receive a tracked e-mail message and the appropriate titles of the departments, regions, companies, or whatever level the tracking is set, depending on the implementation, all appear in tracking area 410 as location information 418, with the recipients grouped accordingly under each heading.

As shown in FIG. 4, users A, B, X, and Y are depicted under the IT heading, indicating that users A, B, X, and Y are all members of the IT department. User C is depicted under the marketing header, indicating that user C is a member of the marketing department. User Z is depicted under the external heading, indicating that either user Z is not an employee of the company or that an e-mail was sent to a non-work e-mail address of an employee.

Path information 420 shows that the originator of the e-mail message sent the e-mail and attachment 408 to three (3) recipients, users A, X, and Y, all of whom are in the IT department. Path information 420 shows that user A sent the e-mail to user B, who is also in the IT department. User B also forwarded the message to a user C, who is located in the marketing department.

As user C is in marketing, the originator may wonder why the e-mail was sent to user C, as the e-mail message specifically requested that the information be treated confidentially. Thus, the originator may contact either user B or C to ascertain why the e-mail was forwarded to user C.

By selecting, or mousing over, the icon for user C, usage information 416 is displayed. Usage information displayed in usage information 416 includes both e-mail usage information and attachment usage information. Usage information 416 comprises the full e-mail address of user C; as well as statistics regarding the number of times the e-mail has been copied, opened, and modified by user C alone. Further, usage information 416 comprises statistics regarding the number of times attachment 408 has been copied, opened, modified, and forwarded by user C. In an alternate embodiment, a user has the option of electing to display cumulative e-mail and attachment usage information. The cumulative information may be displayed alone or as part of the information that comprises tracking area 410.

Noting the e-mail has been modified by user C, the originator may wish to contact user C to determine why the e-mail has been modified and what content has been modified. Path information 420 also indicates that user X has forwarded the confidential e-mail and attachment to an external party, user Z. As user Z is an external user, there is a flag, or visual iconic representation, associated with user Z that alerts the user that user Z is an outside, or external party. As the e-mail and attachment are confidential information, the originator may need to contact a manager or supervisor, letting them know of the situation and get advice on how to proceed.

In an exemplary embodiment, a user has the option to assign flags for questionable activity. Questionable activity will vary with specific implementations and is based on the context of use, but some examples include, but are not limited to, sending an e-mail or attachment to an outside party, modifying an e-mail or attachment, downloading an attachment, and so forth. Flagging means to cause a visual, iconic representation to appear in a display. The flag could actually be a flag or any other appropriate symbol or visual indications, such as for example, but not limited to, an exclamation point, a question mark, a skull and crossbones, an x, a stop sign, a flashing icon, a different colored icon, such as red, or any other appropriate visual indicator.

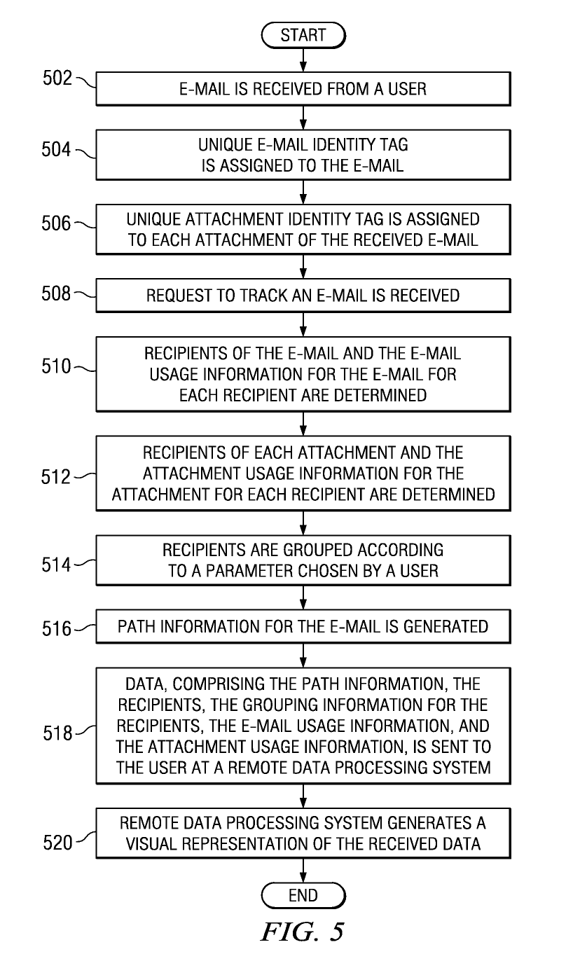

FIG. 5 is flowchart illustrating the operation of tracking an e-mail and e-mail attachments in accordance with a preferred embodiment. The operation of FIG. 5 may be implemented in an e-mail server, such as e-mail server 302 in FIG. 3, through an API, such as tracking API 312 in FIG. 3. The operation begins when an e-mail is received from a user (step 502). A unique e-mail identity tag is assigned to the e-mail (step 504). A unique attachment identity tag is assigned to each attachment of the received e-mail (step 506). The e-mail identity tag and attachment identity tags cross-reference each other. The e-mail identity tag is used to track recipients of the e-mail and e-mail usage information. The attachment identity tag is used to track recipients of the attachment and attachment usage information.

A request to track an e-mail is received (step 508). The recipients of the e-mail and the e-mail usage information for the e-mail for each recipient are determined (step 510). The recipients of each attachment and the attachment usage information for the attachment for each recipient are determined (step 512). The recipients are grouped according to a parameter chosen by a user (step 514). The parameter may be based on a physical location, or by department, group, or so forth, as appropriate for any particular e-mail. Path information for the e-mail is generated (step 516). Data, comprising the path information, the recipients, the grouping information for the recipients, the e-mail usage information, and the attachment usage information, is sent to the user at a remote data processing system (step 518). The remote data processing system generates a visual representation of the received data (step 520) and the operation ends.

Thus, exemplary embodiments enable a user to see the path that an email or an attachment took, including the recipient's identity, and to display usage information, such as how many times the e-mail and attachment have been read, copied, forwarded, edited, and so forth.

Tracking e-mails and attachments provides benefits to the corporate, legal, and educational fields. The tracking of e-mails and attachments serves as a document trail for confidential documents, audits, and legal situations. Further, tracking e-mails and attachments will also help detect plagiarism and cheating in educational settings.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories, which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for tracking e-mail and e-mail attachment usage information, the method comprising:
responsive to receiving an e-mail, associating an e-mail identity tag to the e-mail;
responsive to a determination that the e-mail comprises at least one attachment; associating an attachment identity tag to the at least on attachment, wherein the attachment identity tag is associated with the e-mail identity tag.;
receiving a request to track an e-mail;
determining recipients of the e-mail;
determining e-mail usage information for the e-mail for each recipient based on the e-mail identity tag;
responsive to a determination that the e-mail identity tag is associated with at least attachment identity tag, determining attachment usage information for the at least one attachment for each recipient based on the attachment identity tag;
grouping recipients;
generating path information for the e-mail;
sending data comprising, the e-mail usage information, the attachment usage information, the path information, and grouping information, to a remote data processing system; and
displaying a visual representation of the data at the remote data processing system.

2. The computer implemented method of claim 1, further comprising:
selecting a parameter for grouping the recipients.

3. The computer implemented method of claim 1, wherein e-mail usage information comprises:
information regarding how many times the e-mail is opened, copied, sent, forwarded, and edited;
information regarding an identity of users that opened, copied, sent, forwarded, and edited the e-mail; and
information regarding an identity of users that received the e-mail.

4. The computer implemented method of claim 1, wherein attachment usage information comprises:
information regarding how many times the attachment has been opened, forward, copied, modified, and sent;
information regarding an identity of users to whom the attachment has been sent; and
information regarding an identity of users that modified, opened, forwarded, copied, or sent the attachment.

5. The computer implemented method of claim 1, further comprising:
selecting a parameter that defines an activity as questionable; and
presenting an iconic representation of the questionable activity in the visual representation of the data displayed on the remote data processing system.

6. The computer implemented method of claim 1, wherein the visual representation of the data comprises a visual representation of a path of the e-mail, wherein the path shows each recipient of the e-mail.

7. The computer implemented method of claim 6, further comprising:
displaying the e-mail usage information and the attachment usage information for each individual recipient at the remote data processing system.

8. The computer implemented method of claim 6, wherein the e-mail usage information and the attachment usage information are displayed cumulatively at a display of each recipient.

9. The computer implemented method of claim 1, wherein the e-mail usage information is associated with the e-mail identity tag.

10. The computer implemented method of claim 1, wherein the attachment usage information is associated with the attachment identity tag.

11. A computer program product comprising:
a tangible computer-usable medium having computer-usable program code for tracking e-mail and e-mail attachment usage information, the computer program product comprising:
computer-usable program code for receiving a request to track an e-mail;
computer-usable program code for determining recipients of the e-mail;
computer-usable program code for determining e-mail usage information for the e-mail for each recipient;
computer-usable program code for determining whether the e-mail comprises at least one attachment;
computer-usable program code, responsive to a determination that the e-mail comprises at least one attachment, for determining attachment usage information for the at least one attachment for each recipient;
computer-usable program code for grouping recipients based on a location of each recipient;
computer-usable program code for generating path information for the e-mail;
computer-usable program code for sending data comprising, the e-mail usage information, the attachment usage information, the path information, and grouping information, to a remote data processing system; and
computer-usable program code for displaying a visual representation of the data at the remote data processing system.

12. The computer program product of claim 11, further comprising:
computer-usable program code for selecting a parameter for grouping the recipients.

13. The computer program product of claim 11, wherein e-mail usage information comprises:
information regarding how many times the e-mail is opened, copied, sent, forwarded, and edited;
information regarding an identity of users that opened, copied, sent, forwarded, and edited the e-mail; and
information regarding an identity of users that received the e-mail.

14. The computer program product of claim 11, wherein attachment usage information comprises:
information regarding many times the attachment has been opened, forward, copied, modified, and sent;
information regarding an identity of users to whom the attachment has been sent; and
information regarding an identity of users that modified, opened, forwarded, copied, or sent the attachment.

15. The computer program product of claim 11, further comprising:
computer-usable program code for selecting a parameter that defines an activity as questionable; and
computer-usable program code for presenting an iconic representation of the questionable activity in the visual representation of the data displayed on the remote data processing system.

16. The computer program product of claim 11, wherein the computer-usable program code for displaying a visual representation of the data at the remote data processing system comprises computer-usable program code for displaying a visual representation of a path of the e-mail, wherein the path shows each recipient of the e-mail.

17. The computer program product of claim 16, wherein the computer-usable program code for displaying a visual representation of the data at the remote data processing system further comprises computer-usable program code for displaying the e-mail usage information and the attachment usage information for each individual recipient.

18. The computer program product of claim 11, wherein the e-mail usage information is associated with the e-mail identity tag.

19. The computer program product of claim 11, wherein the attachment usage information is associated with the attachment identity tag.

20. A data processing system for tracking e-mail and e-mail attachment usage information, the data processing system comprising:
a memory, wherein the memory stores instructions;
a bus connected to the memory; and
a processor, wherein the processor is configured to execute the instructions to receive a request to track an e-mail; determine recipients of the e-mail; determine e-mail usage information for the e-mail for each recipient; determine whether the e-mail comprises at least one attachment; responsive to a determination that the e-mail comprises at least one attachment, determine attachment usage information for the at least one attachment for each recipient; group recipients based on a location of each recipient; generate path information for the e-mail; send data comprising, the e-mail usage information, the attachment usage information, the path information, and grouping information, to a remote data processing system; and display a visual representation of the data at the remote data processing system.
